(19) United States
(12) Patent Application Publication
(10) Pub. No.: US 2008/0277603 A1
(43) Pub. Date: Nov. 13, 2008

(54) Shielded Containment System and Method of Operating the Same

(76) Inventors: Paul H. Yanke, Milwaukee, WI (US); Scott H. Yanke, Milwaukee, WI (US); Charles H. Yanke, Milwaukee, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/911,991

(22) PCT Filed: Apr. 20, 2006
(86) PCT No.: PCT/US06/14910

§ 371 Date: Jun. 19, 2008

Related U.S. Application Data
(60) Provisional application No. 60/673,833, filed on Apr. 22, 2005.

(51) Int. Cl. G21F 5/00

(52) U.S. Cl. 250/506.1

(57) ABSTRACT

A radiation containment system includes a vessel for storing a radioactive package, the vessel including an outer wall defining an interior area, and a shield formed of radiation shielding material. The shield is positioned adjacent the vessel for minimizing dispersal of radioactive material from the interior area of the vessel.

### CROSS-REFERENCE TO RELATED APPLICATION

This application claims priority from U.S. Provisional Patent Application No. 60/673,833, entitled “Shielded Containment System and Method of Operating the Same”, filed Apr. 22, 2005 by Paul H. Yanke, Scott H. Yanke and Charles H. Yanke.

### BACKGROUND

The present invention relates to shielded containment systems and methods of operating the same.

Containment systems are used for transporting and storing suspect packages, as well as containing an explosion. The containment systems provide an affordable means to safely contain a suspect package and distance the package from persons, equipment, and other structures until a bomb squad can respond. One example of a containment system is a suspect luggage containment vessel made by NABCO, Incorporated (Canonsburg, Pa.), which quickly and safely contains luggage that has been identified as suspect during screening operations. Typically, containment systems include an external shell and a series of reinforcements and shock absorbing material between the shells. Containment systems contain and absorb an explosion, accidental or intentional, to prevent damage to surrounding persons, environment, or structures. However, if radioactive explosives are stored or detonated within the containment system, the containment system does not prevent dispersal of radiation from the vessel. Thus, the containment system provides no protection to surrounding persons, environment, or structures from radiation exposure.

### SUMMARY

In one embodiment, the invention provides a radiation containment system including a vessel for storing a radioactive package, the vessel having an outer wall defining an interior area. The system also includes a shield formed of radiation shielding material, and the shield is positioned adjacent the vessel for minimizing dispersal of radioactive material from the interior area of the vessel.

In another embodiment, the invention provides a radiation containment system for storing a suspect package and minimizing dispersal of radioactive material. The radiation containment system includes a vessel having an outer wall defining an interior area, an opening through the outer wall for accessing the interior area, a door providing access to the interior area of the vessel, and a radiation shield formed of a radiation shielding material. The shield is positioned adjacent to a portion of the vessel.

In yet another embodiment, the invention provides a radiation containment system for storing a suspect package and minimizing dispersal of radioactive material. The radiation containment system includes a vessel having an outer wall defining an interior area, the outer wall at least in part formed by a radiation shielding material, an opening through the outer wall for accessing the interior area, and a door providing access to the interior area of the vessel.

In one embodiment the invention provides a method for using a radiation containment system to reduce exposure to radioactive material. The method includes providing a radiation containment system having an outer wall defining an interior area, an opening through the outer wall for accessing the interior area, and a door providing access to the interior area of the system. A shield is positioned adjacent the outer wall of the system, the shield being formed of a radiation shielding material, and a package is placed in the interior area of the radiation containment system wherein the shield minimizes dispersal of radiation from the package.

Other aspects of the invention will become apparent by consideration of the detailed description and accompanying drawings.

### BRIEF DESCRIPTION OF THE DRAWINGS

FIG. 1 is a perspective view of a containment system according to some embodiments of the present invention.

FIG. 2 is an exploded perspective view of a portion of the containment system shown in FIG. 1.

FIG. 3 is a cross sectional view of a portion of the containment system taken along line 3-3.

FIG. 4 is an exploded perspective view of a portion of a containment system according to another embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

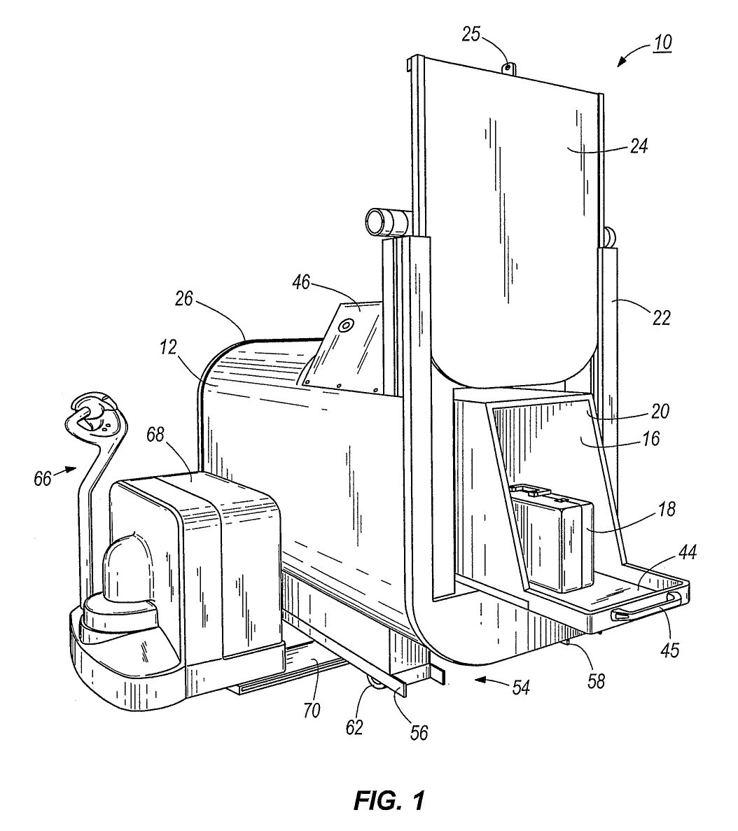

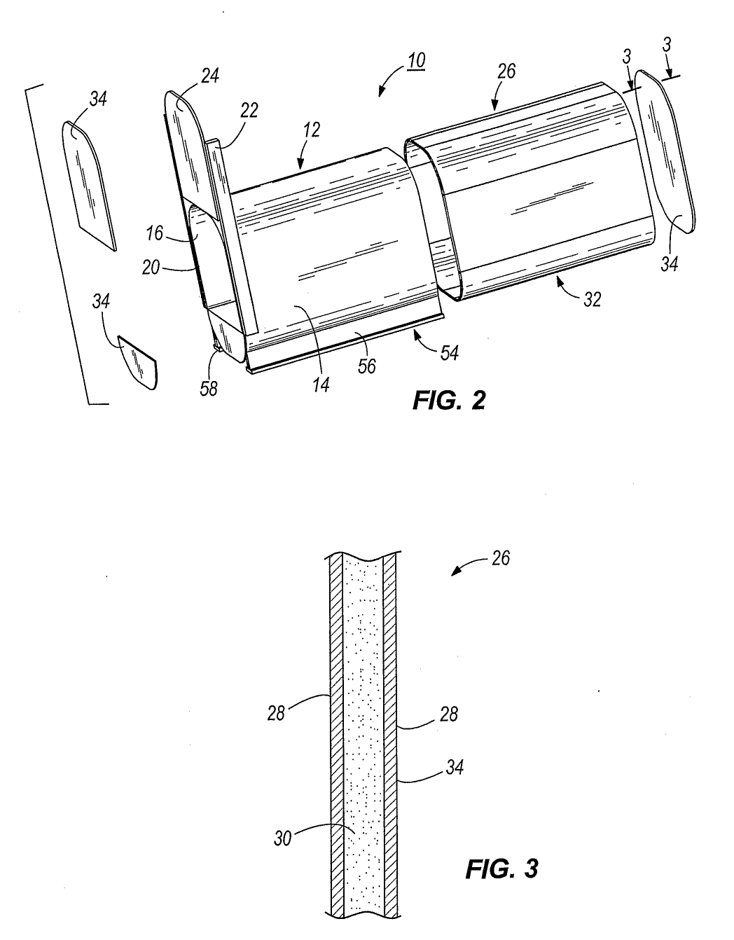

FIGS. 1 and 2 illustrate a containment system 10 according to some embodiments of the present invention. As explained below, the containment system 10 is especially suitable for use in the safe disposal and transportation of hazardous materials, including radioactive materials, explosive materials, toxic materials, poisonous materials, radioactive materials, biological agents, and chemical agents, and objects 18 having or expected of having one or more such hazardous materials. In the illustrated embodiment, the containment system 10 is a suspect luggage containment vessel for quickly and safely containing luggage that has been identified as suspect during screening operations. It should be readily apparent to those of skill in the art that other known containment vessels may be used.

In the illustrated embodiment of FIGS. 1 and 2, the containment system 10 includes a vessel 12, or container, having an outer wall 14, which at least partially encloses an interior space 16 for receiving hazardous objects 18. The containment system 10 also includes an opening 20, which communicates between atmosphere and the interior space 16, and a door frame 22, which substantially surrounds the opening 20.

The door frame 22 supports a door 24 for movement relative to the door frame 22 between an opened position (shown in FIGS. 1 and 2), and a closed position (not shown). In the open position, the door 24 is moved away from or out of the opening 20, and in the closed position, the door 24 substantially covers the opening 20, thereby preventing access to the interior space 16 through the opening 20. The vessel 12 includes a latch 25 for securing the door 24 in the closed position. In some applications, a lock (not shown) or a bolt is connected to the latch 25 to further secure the door 24 in the closed position and to prevent or limit unauthorized access to the interior space 16.

In the illustrated embodiments, the containment system 10 includes a radiation shield 26 for preventing dispersal of radiation from the vessel 12 from radioactive materials stored or detonated within the containment system 10. Referring to FIG. 2, the radiation shield 26 is a shroud or sleeve 32 that covers at least a portion of the outer wall 14 of the container 12. The shield 26 substantially encloses the outer wall 14 of the container 12 and in a further embodiment may cover the door 24 and opposite end of the container 12.

The shield 26 may be formed from multiple materials and have multiple layers. For example, as illustrated by FIG. 3, the shield 26 is formed of multiple layers of stainless steel plating 28 that are formed or molded around a core or radiation shield 30. In some embodiments, the core 30 may include or be formed from lead. It should be readily apparent to those of skill in the art that in further embodiments, the core 30 may be formed from or include other radiation-shielding materials, such as tungsten. In still other embodiments, the shield 26 is manufactured from or includes other materials, including plastics, other synthetic materials, ceramics, fiberglass, iron, and the like. In these embodiments, the shield 26 is molded (e.g., injection molded) from a plastic material or the shield 26 is manufactured in any other manner, such as by casting, stamping, machining, bending, pressing, extruding, or other manufacturing operations.

In embodiments where the shield 26 includes stainless steel plating 28 and a core 30, the plating 28 absorbs and contains explosions, thereby minimizing the potential dangers of objects 18 contained in the interior space 16. The plating 28 also protects objects 18 contained in the interior space 16 from impacts and environmental damage during storage and transportation of the objects 18. The core 30 provides radiological insulation to contain or minimize the dispersion of potential harmful radiological or nuclear materials contained in the interior space 16. The core 30 also operates to absorb and contain explosions and to protect objects 18 contained in the interior space 16.

In one embodiment, the shield 26 may be formed from a single continuous panel or sheet, although referring to FIG. 2, the shield 26 may also be formed from a number of individual interconnected panels. In embodiments having multiple layers and/or being formed of multiple panels, the layers and/or panels are secured together, for example by welding, threaded fasteners, rivets, pins, clamps, or other fasteners, by snap fits, inter-engaging elements, adhesive or cohesive bonding material, by brazing, or soldering, and the like.

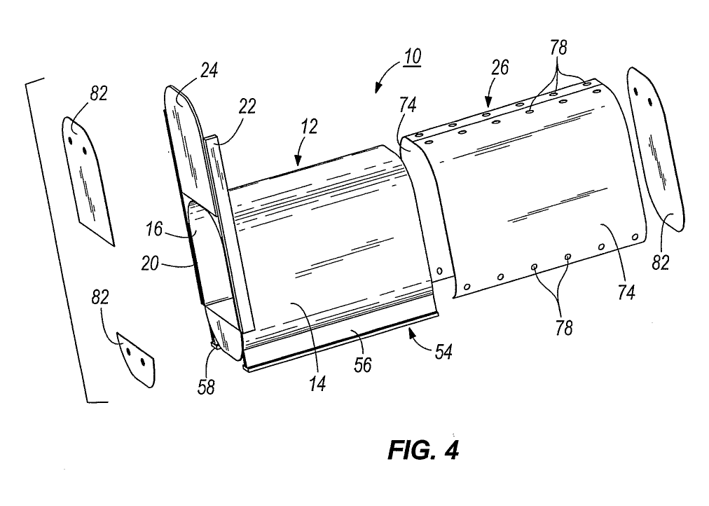

In another embodiment, such as the one shown in FIG. 4, the shield 26 is formed of radiation shielding blankets 74 mounted to the container 12. The shield 26 may be comprised of multiple blankets or a single blanket arranged around the container 12. The radiation shielding blankets 74 are formed from lead wool rope and are encased in a nylon reinforced PVC covering. Each blanket 74 includes grommets 78 defining an aperture for receiving a bolt, or other fastener, to couple the blanket 74 to the container 12. In the illustrated embodiment, the shield includes end blankets 82 that are coupled to front and rear ends of the container 12 and to the container door 24. It should be readily apparent to those of skill in the art that other radiation shielding materials may be used to form the blanket(s), other materials for the blanket covering may be used, or the covering may be eliminated.

Referring to FIG. 2, in one embodiment, the shield 26 includes a sleeve 32 that is formed around side walls, upper wall, and lower wall (i.e., the outer wall 14) of the container 12. The shield 26 includes end plates 34 that are secured to the front and rear ends of the container 12 and to the container door 24. In this embodiment, the sleeve 32 and the end plates 34 are configured and/or oriented to include overlapping portions to prevent hazardous materials from escaping between the sleeve 32 and the end plates 34.

In one embodiment, the shield 26 may include a seal, which is positioned between the shield 26 and the outer wall 14 of the container 12 to prevent radiological materials or other hazardous materials from leaking out of the interior space 16 between the shroud 26 and the outer wall 14. The seal may include interlocking or overlapping protrusions, panels, or tabs, or the seal may include one or more elastic and/or insulating elements positioned between the shroud 26 and the outer wall 14 of the container 12. Without a seal, the container 12 contains radiation when a suspect package is stored in the container 12 and contains a blast if the suspect package explodes; however, the container 12 may not contain radioactive gases during an explosion. With a seal, the container 12 will contain radioactive gases during an explosion.

In another embodiment and referring to FIG. 1, the outer wall 14 of the container 12 includes an integral core 30 and stainless steel plating 28 surrounding the core 30 (FIG. 3). Thereby, the outerwall 14 forms the radiation shield 26. In this embodiment, the containment system 10 may include a supplemental shield surrounding at least a portion of the outer wall 14. In still another embodiment, an interior wall (not shown) of the container 12 may include a radiation shield, or be lined with lead or another radiation-shielding material, such as tungsten.

Referring to FIG. 2, the containment system 10 includes a support tray 44 removably supported in the interior space 16 and having a handle or grip portion. During operation of the containment system 10 and as described in greater detail below, the support tray 44 is removed from the interior space 16 to receive one or more hazardous objects 18. Once an operator or a robot places a hazardous object 18 on the support tray 44, the tray 44 and the object 18 are inserted into the interior space 16. In further embodiments, the tray 44 includes a radiation shield or may be fabricated from a radiation shielding material.

The containment system 10 also includes a drive system 46, which is operable to move the door 24 of the container 12 between the opened and closed positions. In one embodiment, the drive system 46 is operable to remotely move the door 24 of the container 12 between the opened and closed positions so that an operator is not required to approach the hazardous object 18 to operate the door 24. The drive system 46 includes a power supply (not shown) for powering operation of the drive system 46. The power supply may be a chemical or stored energy system, such as a battery, or the power supply may be an external power source, such as a generator, an AC power source, and the like.

The containment system 10 includes a support frame 54 connected to an underside of the container 12 and having a first leg 56 and a second leg 58 positioned on opposite sides of the container 12. The support frame 54 supports the container 12 in an elevated position above the ground or the floor so that a hand cart, dolly, forklift, or other carrier may more easily lift the containment system 10 off of the ground or the floor and move the containment system 10 from a first location to a second, remote location. In a further embodiment, the support frame 54 includes openings for receiving portions of a hand cart, dolly, forklift, or other carrier (described below) to facilitate movement of the containment system 10. Referring to FIG. 1, the frame 54 also includes a number of wheels or rollers 62 coupled to the first and second legs 56, 58 to facilitate movement of the containment system 10 between locations. Use of the rollers 62 allows an operator, a robot, or a carrier 66 to push, pull, or drag the containment system 10 more easily between locations. In one embodiment, the containment system 10 includes a dedicated carrier 66, although other, non-dedicated carriers may be operable to move the containment system 10 between locations.

In the illustrated embodiment, the carrier 66 includes a drive motor 68 and a lifting mechanism 70. The lifting mechanism 70 is positionable adjacent to or under the container 12 and/or the support frame 54 and is operable to lift the container 12 off of the ground and to hold the container 12 above the ground as the containment system 10 is moved between locations. The drive motor 68 is operable to move the carrier 66 and the container 12 between locations. The drive motor 68 may be any conventional type of driving unit, such as, for example, an electric motor, an engine, a hydraulic motor, and the like.

In one embodiment, the containment system 10 includes a controller (not shown) for coordinating and controlling operation of the containment system 10. The controller is operable to control and coordinate movement of the container door 24 between the opened and closed positions, and may be operable to control and coordinate operation of the carrier 66. Further, the controller may be operable to remotely control the container door 24 and/or the carrier 66 so that the containment system 10 is controllable without requiring an operator to approach the containment system 10.

In operation, when a hazardous object 18 is located, the containment system 10 is moved to the location of the hazardous object 18. The container door 24 is moved toward the opened position and the hazardous object 18 is inserted into the interior space 16. In embodiments having a support tray 44, the support tray 44 is removed from the container 12 to facilitate movement of the hazardous object 18 into the interior space 16. In other embodiments, robots, operators, conveyor belts, forklifts, and other product moving devices may be used to move the hazardous object 18 into the interior space 16.

Once the hazardous object 18 is positioned in the interior space 16, the container door 24 is moved to the closed position to isolate the hazardous object 18. The latch 25 may also be moved to a locked position to secure the container door 24 in the closed position. A controller may be programmed to move the container door 24 to the closed position and to move the latch 25 to the locked position when a hazardous object 18 is loaded into the interior space 16 so that an operator does not have to approach the hazardous object 18 or the containment system 10.

Once a hazardous object 18 is loaded into the container 12, the containment system 10 may be moved to a remote location for safe disposal or inspection. If a hazardous object 18 explodes, leaks, releases harmful agents or materials, or releases radiation while sealed in the interior space 16, the outer wall 14 of the container 12, the door 24, and the shield 26 contain the harmful agents or materials in the interior space 16 and prevent these harmful agents or materials from escaping to the atmosphere and causing harm. The outer wall 14 of the container 12, the door 24, and the shield 26 also contain the blast from an explosion.

As explained above, the containment system 10 includes rollers 62 such that the system is movable to a remote location. In other embodiments, the carrier 66 may be used to lift the containment system 10 off of the ground before moving the containment system 10 to a remote location for safe disposal or inspection.

Although particular embodiments of the present invention have been shown and described, other alternative embodiments will be apparent to those skilled in the art and are within the intended scope of the present invention. Various features and advantages of the invention are set forth in the following claims.

What is claimed is:

1. A radiation containment system comprising:
a vessel for storing a radioactive package, the vessel including an outer wall defining an interior area;
a shield formed of radiation shielding material, the shield positioned adjacent the vessel for minimizing dispersal of radioactive material from the interior area of the vessel.

2. The radiation containment system of claim 1 wherein the shield is positioned and arranged to surround at least a portion of an exterior surface of the outer wall.

3. The radiation containment system of claim 2 wherein the shield includes a sleeve formed and shaped to complement a contour of the vessel.

4. The radiation containment system of claim 2 wherein the shield includes an end plate formed of radiation shielding material, the end plate positioned and arranged to surround an end of the vessel.

5. The radiation containment system of claim 1 wherein the shield is positioned adjacent an interior surface of the outer wall.

6. The radiation containment system of claim 1 wherein the shield includes at least one lead wool blanket.

7. The radiation containment system of claim 1 wherein the shield includes a plurality of panels coupled together and shaped to complement a contour of the vessel.

8. The radiation containment system of claim 1 wherein the shield includes a lead core encased in stainless steel.

9. The radiation containment system of claim 1, and further comprising a seal formed of radiation shielding material, the seal positioned between the shield and the outer wall of the vessel.

10. A radiation containment system for storing a suspect package and minimizing dispersal of radioactive material, the radiation containment system comprising:
a vessel including an outer wall defining an interior area;
an opening through the outer wall for accessing the interior area;
a door providing access to the interior area of the vessel; and
a radiation shield formed of a radiation shielding material and positioned adjacent to a portion of the vessel.

11. The radiation containment system of claim 10 wherein the radiation shield is positioned and arranged to surround at least a portion of an exterior surface of the vessel.

12. The radiation containment system of claim 11 wherein the radiation shield a sleeve formed and shaped to complement a contour of the vessel.

13. The radiation containment system of claim 11 wherein the shield includes an end plate formed of radiation shielding material, the end plate positioned and arranged to surround an end of the vessel.

14. The radiation containment system of claim 10 wherein the radiation shield is positioned within the interior area and adjacent an interior surface of the vessel.

15. The radiation containment system of claim 10 wherein the radiation shield comprises a plurality of panels coupled together and shaped to complement a contour of the vessel.

16. The radiation containment system of claim 15 wherein each panel overlaps with an adjacent panel to prevent line of sight radiation.

17. The radiation containment system of claim 10 wherein the shield includes at least one lead wool blanket.

18. The radiation containment system of claim 10 wherein the radiation shield includes a lead core substantially covered by a casing.

19. The radiation containment system of claim 10 and further comprising a door shield formed of radiation shielding material, the door shield coupled to an exterior surface of the door.

20. The radiation containment system of claim 10, and further comprising a seal formed of radiation shielding material, the seal positioned between the shield and the outer wall of the vessel.

21. The radiation containment system of claim 10, and further comprising a tray selectively removable from the interior area of the vessel wherein the at least a portion of the tray includes a radiation shield formed of a radiation shielding material.

22. A radiation containment system for storing a suspect package and minimizing dispersal of radioactive material, the radiation containment system comprising:
a vessel including an outer wall defining an interior area, the outer wall at least in part formed by a radiation shielding material;
an opening through the outer wall for accessing the interior area; and
a door providing access to the interior area of the vessel.

23. The radiation containment system of claim 22 wherein the outer wall is formed of a lead core substantially covered by a stainless steel casing.

24. The radiation containment system of claim 22 and further comprising a door shield formed of radiation shielding material, the door shield coupled to an exterior surface of the door.

25. The radiation containment system of claim 22, and further comprising a radiation shield formed of radiation shielding material positioned adjacent to a portion of the vessel.

26. The radiation containment system of claim 22, and further comprising a tray selectively removable from the interior area of the vessel wherein the at least a portion of the tray includes a radiation shield formed of a radiation shielding material.

27. A method for using a radiation containment system to reduce exposure to radioactive material, the method comprising:
providing a radiation containment system including an outer wall defining an interior area, an opening through the outer wall for accessing the interior area, and a door providing access to the interior area of the system;
positioning a shield adjacent the outer wall of the system, the shield being formed of a radiation shielding material; and
placing a package in the interior area of the radiation containment system wherein the shield minimizes dispersal of radiation from the package.

28. The method of claim 24, and further comprising detonating the package within the radiation containment system wherein the shield minimizes dispersal of radiation from the package.

29. The method of claim 24 wherein positioning the shield comprises positioning the shield adjacent an exterior surface of the outer wall wherein the shield surrounds a portion of the system.

30. The method of claim 24 wherein positioning the shield comprises positioning the shield within the interior area and adjacent an interior surface of the outer wall.
